(19) United States
(12) Patent Application Publication
(10) Pub. No.: US 2025/0245890 A1
(43) Pub. Date: Jul. 31, 2025

(54) SYSTEMS AND METHODS OF AUTOMATED GENERATION OF CREATIVES

(71) Applicant: Walmart Apollo, LLC, Bentonville, AR (US)

(72) Inventors: Mahesh Reginthala, Andhra Pradesh (IN); Arpan Maheshwari, Madhya Pradesh (IN); Kunal Kishore, Jharkhand (IN); Swapna Sarit Sahu, Bangalore (IN)

(21) Appl. No.: 19/012,773

(22) Filed: Jan. 7, 2025

Related U.S. Application Data
(60) Provisional application No. 63/627,227, filed on Jan. 31, 2024.

(51) Int. Cl. G06T 11/60

(52) U.S. Cl. CPC G06T 11/60; G06T 2200/24

(57) ABSTRACT

Example implementations related to automated generation of images is disclosed. In an example, a request to generate an interface element package for a selected item is received and, in response to receiving the request, a foreground image element and a contextually appropriate background image are generated. An integrated image is generated by integrating the foreground image element into the contextually appropriate background image at a contextually appropriate position. The foreground image element is unmodified in the integrated image. At least one textual interface element is generated. The interface element package includes at least the integrated image and the textual interface element.

### CROSS-REFERENCE TO RELATED APPLICATION

This application claims benefit under 35 U.S.C. § 119 (e) to U.S. Provisional App. Ser. No. 63/627,227, filed Jan. 31, 2024, entitled “Systems and Methods of Automated Generation of Creatives,” the disclosure of which is incorporated by reference herein in its entirety.

### TECHNICAL FIELD

This application relates generally to automated generation of images, and more particularly, to automated generation of images for identified items.

### BACKGROUND

Generation of meaningful and aesthetical images is required in many different domains, including interface generation, website generation, etc. One class of such images is referred to as “creatives,” images designed to be shown in conjunction with interface elements related to items, such as interface elements included in ecommerce interfaces. Such creatives typically have three components, an image, a heading, a subheading.

Generation of creatives currently requires significant manual effort and expertise, limiting the use and deployment of creatives to only larger entities within network ecosystems. For example, smaller entities within an ecommerce ecosystem may not be able to afford the time, money, or expertise necessary to generate creatives. In current interfaces, creatives may be replaced by low-quality images, low-variety images, and/or unrelated images.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide an automated image generation pipeline, in accordance with some embodiments;

FIG. 2 illustrates a computer system configured to implement one or more processes, in accordance with some embodiments;

FIG. 3 is a flowchart illustrating an interface element package generation method, in accordance with some embodiments;

FIG. 4 is a process flow illustrating various steps of the interface element package generation method of FIG. 3, in accordance with some embodiments;

FIG. 5 is a flowchart illustrating an integrated image generation method, in accordance with some embodiments;

FIG. 6 is a process flow illustrating various steps of the integrated image generation method of FIG. 5, in accordance with some embodiments;

FIG. 7 illustrates an isolated foreground image element, in accordance with some embodiments;

FIG. 8 illustrates an initial background image, in accordance with some embodiments;

FIG. 9 illustrates a composite image including the foreground image element of FIG. 7 and the initial background image of FIG. 8, in accordance with some embodiments;

FIG. 10 illustrates an image mask corresponding to the composite image of FIG. 9, in accordance with some embodiments;

FIG. 11 illustrates a modified composite image, in accordance with some embodiments;

FIG. 12 illustrates a segmented modified composite image, in accordance with some embodiments;

FIG. 13 illustrates a partial background image, in accordance with some embodiments;

FIG. 14 illustrates an integrated image including a foreground image element integrated into a contextually appropriate background, in accordance with some embodiments;

FIG. 15 illustrates an artificial neural network, in accordance with some embodiments;

FIG. 16 illustrates a tree-based artificial neural network, in accordance with some embodiments;

FIG. 17 illustrates a deep neural network (DNN), in accordance with some embodiments;

FIG. 18 is a flowchart illustrating a training method for generating a trained machine learning model, in accordance with some embodiments; and

FIG. 19 is a process flow illustrating various steps of the training method of FIG. 18, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for automatically generating integrated images. An integrated image includes a foreground element, such as an image of an item, integrated with a contextually appropriate background, in a contextually appropriate position, in order to provide a coherent image. Integration with a contextually appropriate background may include providing expected or sensible interactions between the foreground image element and the background image, such as, for example, contextually appropriate gravity considerations, shadows, touchpoints, etc. In some embodiments, the integrated image is generated in accordance with one or more constraints, such as requiring that an image of the foreground element remain unaltered. Integrated images may include photorealistic images having contextually appropriate color palettes, lighting, etc.

In various embodiments, a foreground data structure is obtained. The foreground element data structure includes at least one image of a foreground element and one or more additional features related to the foreground element. For example, in the context of an ecommerce environment, a foreground element data structure may be representative of an item in an associated item catalog of the ecommerce environment and may include at least one image of the corresponding item. An image generation pipeline is configured to generate a background image contextually appropriate to the at least one image of the foreground image element and integrate the foreground image element into the contextually appropriate background at a contextually appropriate location. In some embodiments, a background image may be refined and/or regenerated based on previously generated background images and/or additional inputs.

In some embodiments, systems, and methods for generating integrated images including a foreground element integrated with a contextually appropriate background includes one or more trained image generation models, such as one or more trained diffusion-based generative models, one or more segmentation models, such as one or more deep learning based segmentation models, and/or any other suitable models. The trained image generation models may include multiple instances of a trained model and/or multiple trained models, such as, for example, a diffusion-based generative model configured to receive a textual input, a diffusion-based generative model configured to receive an image input, a diffusion-based generative model configured to receive a text input and an image input, etc. Similarly, the one or more segmentation models may include multiple instances of a trained model and/or multiple trained models, such as multiple instances of a deep learning segmentation model configured to generate an image mask, as discussed in greater detail below.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc. In some embodiments, a trained function may include a generative function configured to generate content such as text, images, audio, etc. Generative functions may include diffusion-based functions and/or any other suitable generative function.

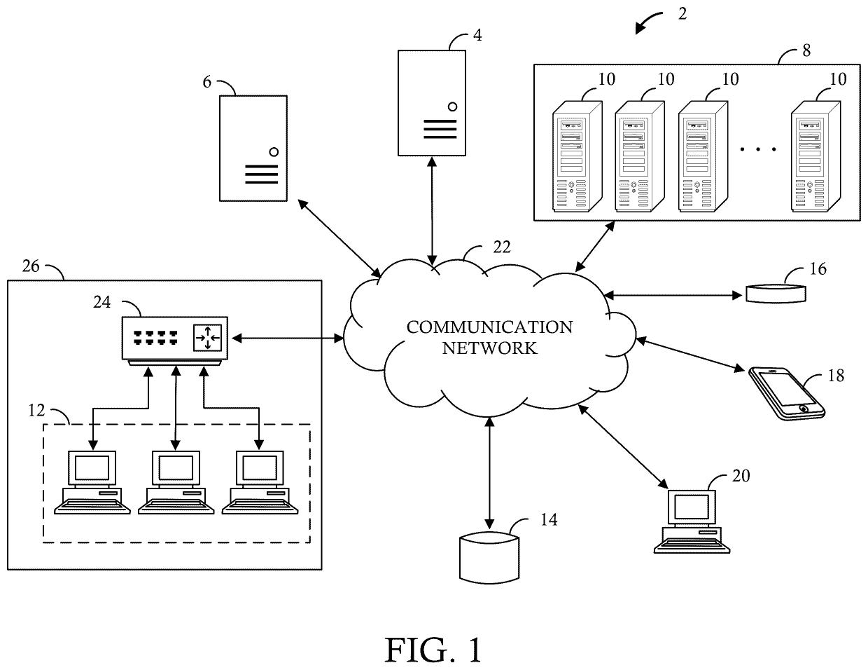

FIG. 1 illustrates a network environment 2 configured to provide an automated image generation pipeline, in accordance with some embodiments. The network environment 2 includes a plurality of devices or systems configured to communicate over one or more network channels, illustrated as a network cloud 22. For example, in various embodiments, the network environment 2 may include, but is not limited to, an image generation computing device 4, a web server 6, a cloud-based engine 8 including one or more processing devices 10, workstation(s) 12, a database 14, and/or one or more user computing devices 16, 18, 20 operatively coupled over the network 22. The image generation computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the image generation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the image generation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment or an image generation environment. In some embodiments, the image generation computing device 4, the processing devices 10, and/or the web server 6 are operated by the network environment provider, and workstation(s) 12 and/or the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the image generation computing device 4, for example. The workstation(s) 12 may communicate with the image generation computing device 4 over the communication network 22. The workstation(s) 12 may send data to, and receive data from, the image generation computing device 4. For example, the workstation(s) 12 may transmit data related to elements selected for integrated image generation, for example, foreground data structures.

Although FIG. 1 illustrates three user computing devices 16, 18, 20, the network environment 2 may include any number of user computing devices 16, 18, 20. Similarly, the network environment 2 may include any number of the image generation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the image generation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an image generation website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as identifying elements for image generation, generating foreground data elements, etc. The website may capture these activities as user session data, and transmit the user session data to the image generation computing device 4 over the communication network 22.

In some embodiments, the image generation computing device 4 may execute one or more models, processes, or algorithms, such as a machine learning model, deep learning model, statistical model, a diffusion-based model, etc., to generate integrated images including a foreground image element integrated into a contextually appropriate background. The image generation computing device 4 may receive an image generation request from the web server 6 over the communication network 22. For example, the web server 6 may display interface elements associated with an item selection interface configured to receive identification of an item and/or other inputs to allow generation of an integrated image by the image generation computing device 4.

The image generation computing device 4 is further operable to communicate with the database 14 over the communication network 22. For example, the image generation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the image generation computing device 4, in some embodiments, the database 14 may be a local storage device, such as a hard drive, a non-volatile memory, or a USB stick. The image generation computing device 4 may store interaction data received from the web server 6 in the database 14. The image generation computing device 4 may also receive from the web server 6 user session data identifying events associated with browsing sessions, and may store the user session data in the database 14.

In some embodiments, the image generation computing device 4 generates training data for a plurality of models (e.g., machine learning models, deep learning models, statistical models, algorithms, etc.) based on existing image data sets, foreground data structures, etc. The image generation computing device 4 and/or one or more of the processing devices 10 may train one or more models based on corresponding training data. The image generation computing device 4 may store the models in a database, such as in the database 14 (e.g., a cloud storage database).

The models, when executed by the image generation computing device 4, allow the image generation computing device 4 to generate integrated images including a foreground image integrated into a contextually appropriate background image. For example, the image generation computing device 4 may obtain one or more models from the database 14. The image generation computing device 4 may then receive, in real-time from the web server 6, an image generation request including a foreground element data structure. In response to receiving image generation request, the image generation computing device 4 may execute one or more models to generate a composite image (e.g., integrated image) including a foreground image element integrated into a contextually appropriate background.

In some embodiments, the image generation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, image generation computing device 4 may generate a composite image (e.g., integrated image) including a foreground image element integrated into a contextually appropriate background.

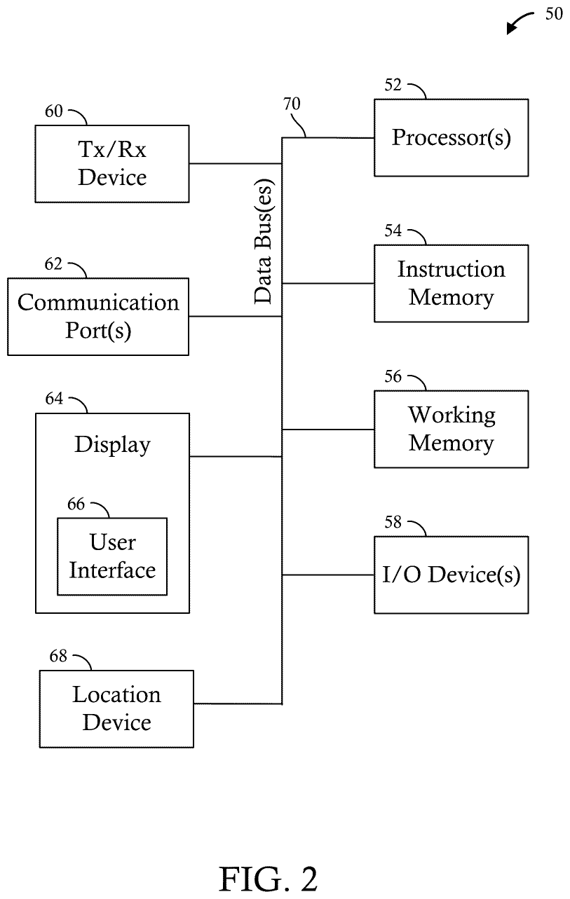

FIG. 2 illustrates a block diagram of a computing device 50, in accordance with some embodiments. In some embodiments, each of the image generation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as integrated image generation methods, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic,. NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with an interface configured to facilitate automated generation of integrated images. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

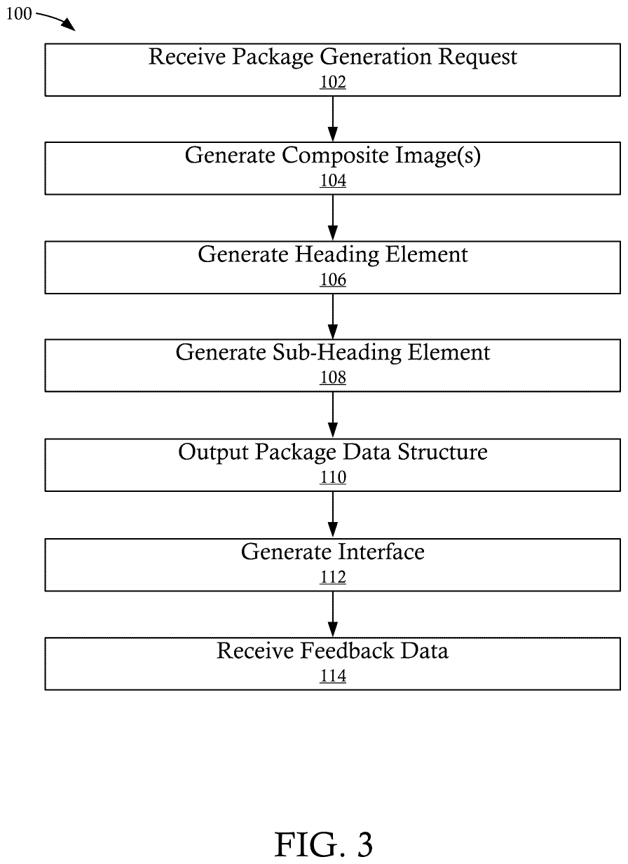

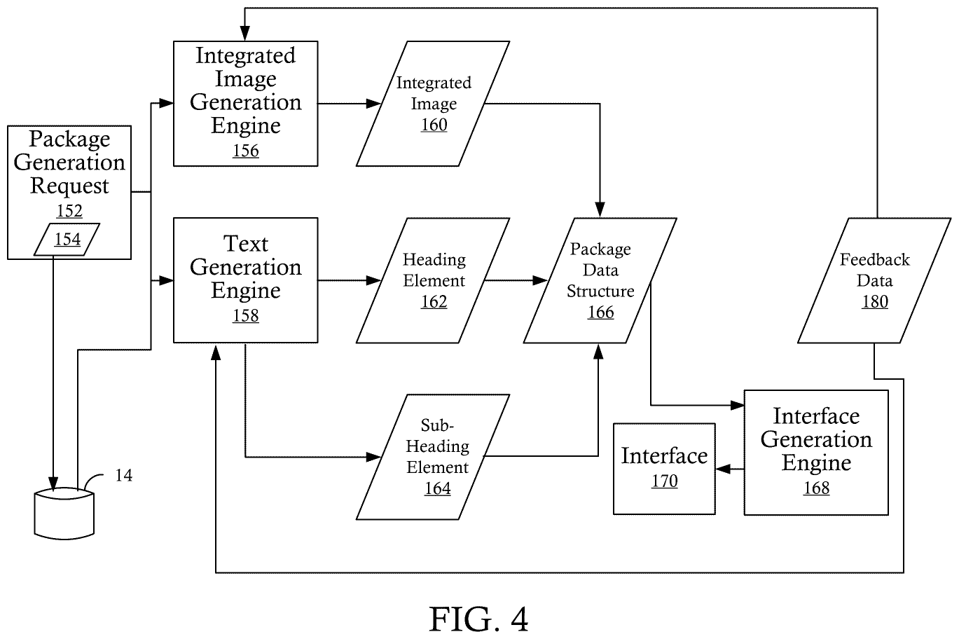

FIG. 3 is a flowchart illustrating an interface element package generation method 100, in accordance with some embodiments. FIG. 4 is a process flow 150 illustrating various steps of the interface element package generation method 100, in accordance with some embodiments. At step 102, a package generation request 152 is received. The package generation request 152 identifies one or more elements (e.g., items) for which one or more interface element package data structures 166 are to be generated. The package generation request 152 may be generated by any suitable system, such as, for example, a user system 16, 18, 20.

In some embodiments, the package generation request 152 includes an identifier 154 configured to identify one or more elements or items associated with a network environment. For example, in the context of an ecommerce environment, the identifier 154 may include an item identifier configured to identify an item included in an item catalog associated with the ecommerce environment. Although specific embodiments are discussed herein, it will be appreciated that the identifier 154 may be configured to identify any suitable element for generation of an interface element package data structure 166, as disclosed herein.

At step 104, an integrated image 160 is generated. The integrated image 160 includes a foreground element representative of an element or item associated with the package generation request 152 integrated with a contextually appropriate background. The integrated image 160 is generated by an automated process, such as an integrated image generation method implemented by an integrated image generation engine 156. The integrated image generation engine 156 may be configured to receive at least a portion of the package generation request 152, such as, for example, an identifier 154, and/or data obtained based on the identifier and implement one or more modules and/or models to generate the integrated image 160. For example, in some embodiments, the identifier 154 may be utilized to retrieve data associated with an element or item from a data store, such as database 14.

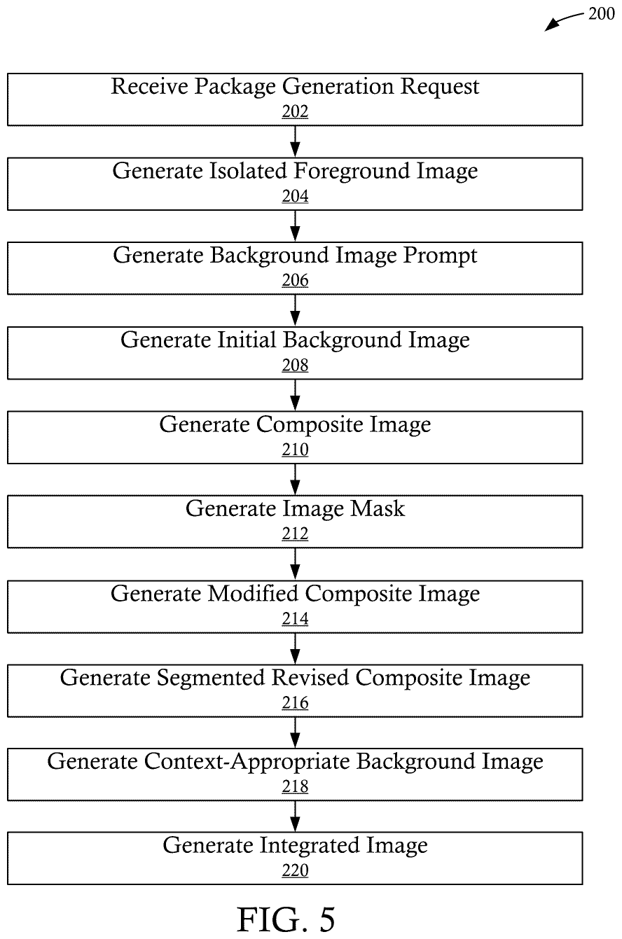

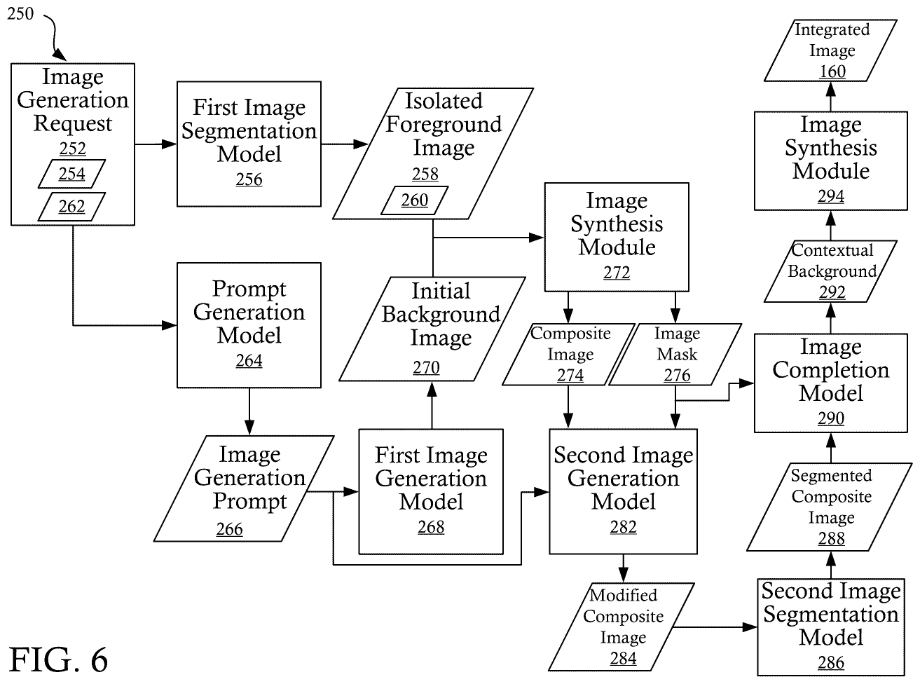

FIG. 5 is a flowchart illustrating an integrated image generation method 200, in accordance with some embodiments. FIG. 6 is a process flow 250 illustrating various steps of the integrated image generation method 200, in accordance with some embodiments. At step 202, an image generation request 252 is received. The image generation request 252 identifies an element selected for (e.g., is the target of) the integrated image generation method 200. In some embodiments, the image generation request 252 includes and/or references element data 254 associated with the selected element. The element data 254 may include any relevant data related to the selected element and utilized by the integrated image generation method 200. For example, the element data 254 may include, but is not limited to, at least one image including selected element, textual elements such as a title, description, etc. of or related to the element, one or more additional features associated with the element, etc. As one non-limiting embodiment, in the context of an ecommerce environment, the selected element may include an item in an item catalog associated with the ecommerce environment and the element data 254 may include one or more images of the item, a plurality of text-based features describing the item (e.g., title, description, brand, etc.), and/or one or more additional features of the item (e.g., color, size, quantity, etc.) In some embodiments, the element data 254 and/or at least one of the feature data elements may be obtained from a database, such as a database 14.

In some embodiments, a first set of features related to the selected element may be obtained from a first source, such as, for example, the element data 254, obtained from a first database related to an associated network environment, etc. A second set of features related to the selected element may be obtained from a second source, such as a second database related to the associated network environment, derived from the element data 254, etc. As one non-limiting example, in the context of an ecommerce environment, the first set of features may include item-specific features obtained from an item entry in an item catalog associated with the ecommerce environment and the second set of features may include related-features, such as a search engine optimization block text, a brand description, etc., obtained from a second data source.

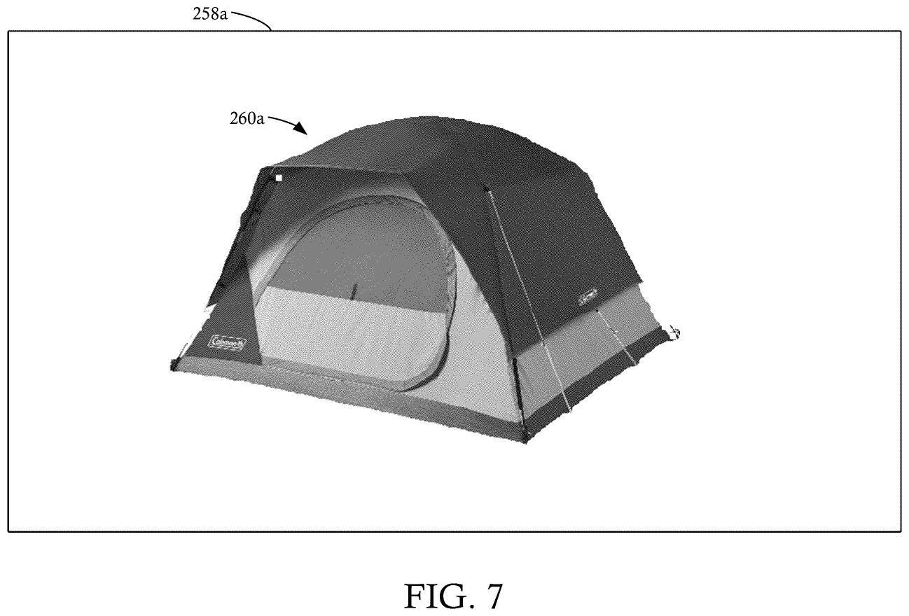

At step 204, an isolated foreground image 258 is generated. The isolated foreground image 258 includes only a foreground image element 260 of the selected item without any other image elements (e.g., background image, other foreground elements, etc.). The isolated foreground image 258 may be generated by removing additional image elements (e.g., background image, other foreground elements, etc.) from an image to isolate the foreground image element 260. In some embodiments, an isolated foreground image 258 includes the foreground image element 260 positioned over a transparent (e.g., empty) background. FIG. 7 illustrates an isolated foreground image 258a including a foreground image element 260a representative of an outdoor camping tent. Although embodiments are discussed herein including the foreground image element 260a, it will be appreciated that the foreground image element 260 may include any image (e.g., photograph, drawing, etc.) of the selected element or aspects thereof.

In some embodiments, the isolated foreground image 258 is generated by a first image segmentation model 256. The first image segmentation model 256 may be configured to receive at least a portion of the element data 254, such as the one or more images including the corresponding foreground image element 260. The first image segmentation model 256 is configured (e.g., trained) to identify boundaries of the foreground image element 260 and remove any other image elements (e.g., background elements, foreground elements, etc.) from the image to generate the isolated foreground image 258. The first image segmentation model 256 may include any suitable trained model, such as, for example, a deep learning-based segmentation model, a graph-based segmentation model, a threshold-based segmentation model, an edge-based segmentation model, a clustering-based segmentation model, a Bayesian-based segmentation model, etc.

In some embodiments, the isolated foreground image 258 may be pre-generated. For example, the element data 254 may include one or more pre-generated isolated foreground images 258 (e.g., image and/or image data containing the foreground image element 260 and a transparent background). In such embodiments, step 204 may be omitted and/or converted into a verification step (e.g., to verify the pre-generated images include only the foreground image element 260).

At step 206, an image generation prompt 266 is automatically generated based on one or elements of the element data 254. In some embodiments, the image generation prompt 266 includes text describing a contextual background for the selected element. The image generation prompt 266 may include natural language text, formatted text, sets of descriptions, and/or any other suitable text format. The image generation prompt 266 is generated in a style configured to be received by an image generation model, as described in greater detail below.

In some embodiments, the image generation prompt 266 is generated from one or more text-based features included in the element data 254. As one non-limiting example, in the context of an ecommerce environment, the one or more features may include, but are not limited to, a title, a brand, a description, a search engine optimization block, etc. It will be appreciated that any suitable text-based features describing and/or related to the selected element may be utilized to generate the image generation prompt 266.

In some embodiments, a set of additional features 262 may be generated and/or extracted from the element data 254. For example, the set of additional features 262 may include one or more sub-features or elements extracted from the one or more features associated with the element data 254. In the context of an ecommerce environment, the set of additional features 262 may include, but is not limited to, category, domain, use, value proposition, styling, vibe, uniqueness, etc. Each of these features may be generated and/or determined from, for example, one or more words or phrases included in each of the text-based features of the element data 254, such as one or more words or phrases included in a title, description, etc.

In some embodiments, the image generation prompt 266 may be generated by a trained prompt generation model 264. The trained prompt generation model 264 is configured to receive at least a portion of the element data 254 and/or at least a portion of the set of additional features 262 associated with the element data 254 as an input and generate a natural language image description. The trained prompt generation model 264 is configured to generate a relevant and creative description of a background scene that is contextually appropriate for the corresponding foreground image element 260. For example, to continue the example from above, the foreground image element 260a includes an outdoor camping tent and the generated natural language image description may provide a description of a background related to an outdoor scene (e.g., describing a forest, mountain, etc. that would be a contextually appropriate setting for an outdoor camping tent). In some embodiments, the trained prompt generation model 264 includes and/or implements an instruction-finetuned transformer based model, such as a trained large language model (LLM), to generate the natural language image description.

In some embodiments, the trained prompt generation model 264 is configured to convert the natural language image description to a image generation prompt 266. For example, the trained prompt generation model 264 may be configured to extract one or more sets of words, phrases, terms, etc. from the natural language image description related to one or more predefined aspects of a background image/image generation prompt 266. For example, an image generation prompt 266 may include a set of words encompassing predefined aspects including, but not limited to, location, background props, medium, environment, color, mood, composition, camera/lens, style references (e.g., websites, artists, etc.). As one non-limiting example, an image generation prompt 266 for the foreground image element 260a may include: (Outdoors, Lush greenery, Towering trees), (Photography), (Sunny, Nature), (Soft, Golden sunlight), (Natural tones, Warm colors), (Adventurous, Tranquil), (Landscape, Encompassing and surroundings), (Prime lens, Wide-angle lens), ([Source 1], [Source 2], etc.), ([Artist 1], [Artist 2], etc.).

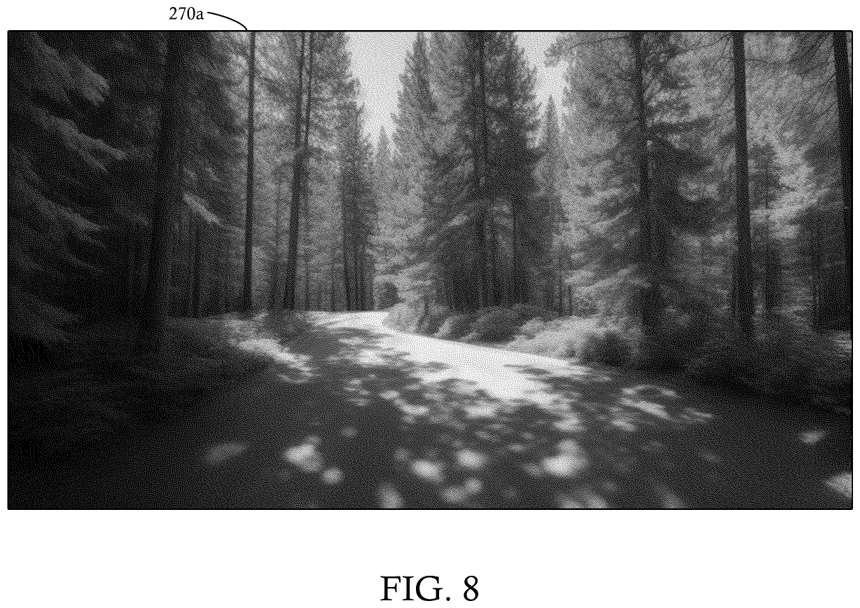

At step 208, an initial background image 270 is generated based on the image generation prompt 266. The initial background image 270 may be generated by any suitable machine learning model, such as, for example, an in-painting model, a photo-realistic model, a non-photo-realistic model, a trained diffusion-based image generation model 268, etc. The diffusion-based image generation model 268 may include a generalized image generation model and/or a specialized image generation model configured to generate images for a selected category, genre, image type, etc. FIG. 8 illustrates an initial background image 270a generated by a trained diffusion-based image generation model 268 based on an image generation prompt similar to the example image generation prompt for the foreground image element 260a discussed above, in accordance with some embodiments.

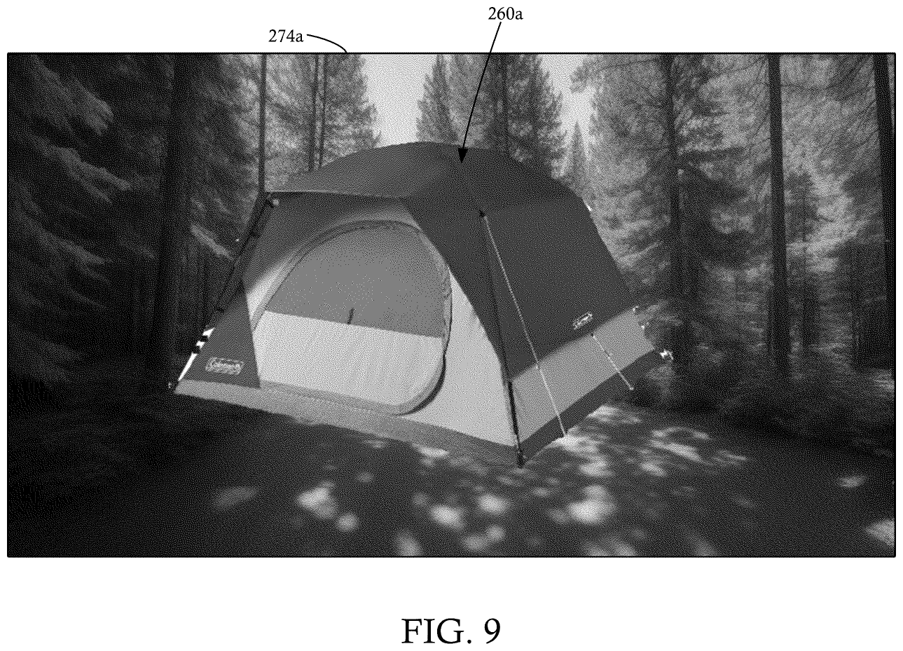

At step 210, the isolated foreground image 258 is overlayed on the initial background image 270 to generate a composite image 274 including the foreground image element 260 positioned atop the initial background image 270. The foreground image element 260 may be randomly positioned on the initial background image 270 and/or may be overlayed in a standardized position (e.g., centered within the initial background image 270). As illustrated in FIG. 9, a composite image 274a may include the foreground image element 260a positioned in a contextually inappropriate position, such as floating in the air.

In some embodiments, the composite image 274 is generated by an image synthesis module 272. The image synthesis module 272 may be configured to receive each of the isolated foreground image 258 and the initial background image 270, overlay the isolated foreground image 258 (e.g., the foreground image element 260) over the initial background image 270, and output the composite image 274. The image synthesis module 272 may utilize any suitable processing techniques to overlay the foreground image element 260 over the initial background image 270.

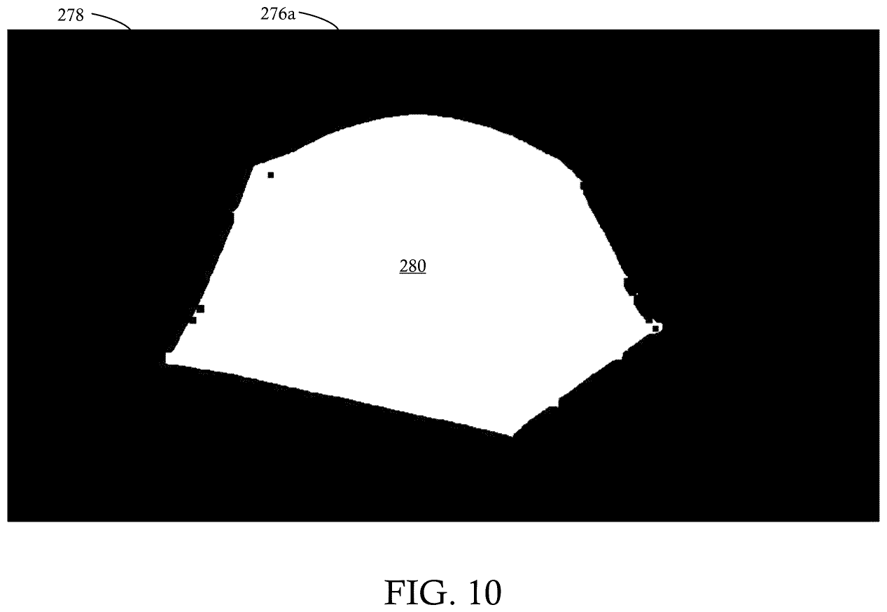

At step 212, an image mask 276 corresponding to the exposed background area of the composite image 274 is generated. The image mask 276 includes a masking overlay of the composite image 274 including a space (e.g., cutout, negative area, etc.) corresponding to the dimensions and location of the foreground image element 260 in the composite image 274. FIG. 10 illustrates an image mask 276a corresponding to the composite image 272a of FIG. 9, in accordance with some embodiments. As illustrated in FIG. 10, the image mask 276a includes a masked region 278 and a non-masked (e.g., negative) region 280.

In some embodiments, the image mask 276 is generated, at least in part, based on the isolated foreground image 258. For example, in some embodiments, the first image segmentation model 256 configured to generate the isolated foreground image 258 may identify a boundary of the foreground image element 260 during segmentation. The identified boundary, in conjunction with overlay and/or positioning information from the composite image 274, may be utilized to provide a location and boundary corresponding to the foreground image element 260 in the composite image 274. As another example, in some embodiments, the isolated foreground image 258 includes a transparent background in a region outside the edges of the foreground image element 260. The background information of the isolated foreground image 258 may be converted into an image mask 276 that includes a negative (or non-masked) area corresponding to the position of the foreground image element 260 in the composite image 274. Although specific embodiments are discussed herein, it will be appreciated that any suitable process may be used to generate the image mask 276.

At step 214, a modified composite image 284 is generated. In some embodiments, the modified composite image 284 is generated by a second image generation model 282 configured to receive the composite image 274, the image mask 276, and the image generation prompt 266. The second image generation model 282 is configured to generate a modified composite image 284 including the foreground image element 260 integrated into a re-generated (or revised) background image. The second image generation model 282 generates the new background image in view of the location and dimensions of the foreground image element 260. For example, the background image may be generated to accurately include shadows, lighting, ground interaction, additional element interactions, etc. with the foreground image element 260 by generating the background image in consideration of a position and dimension of the foreground image element 260.

In some embodiments, the second image generation model 282 is configured to generate a modified composite image 284 including a background image generally corresponding to the masked region 278 of the image mask 276 and a foreground image element 260 generally corresponding to the unmasked region 280 of the image mask 276. Generation of the modified composite image may be initialized based on the composite image 274 and further revised and/or guided by the image generation prompt 266. The second image generation model 282 introduces distortions (e.g., extensions, dimensional changes, etc.) to the foreground image element 260 during generation of the modified composite image 284.

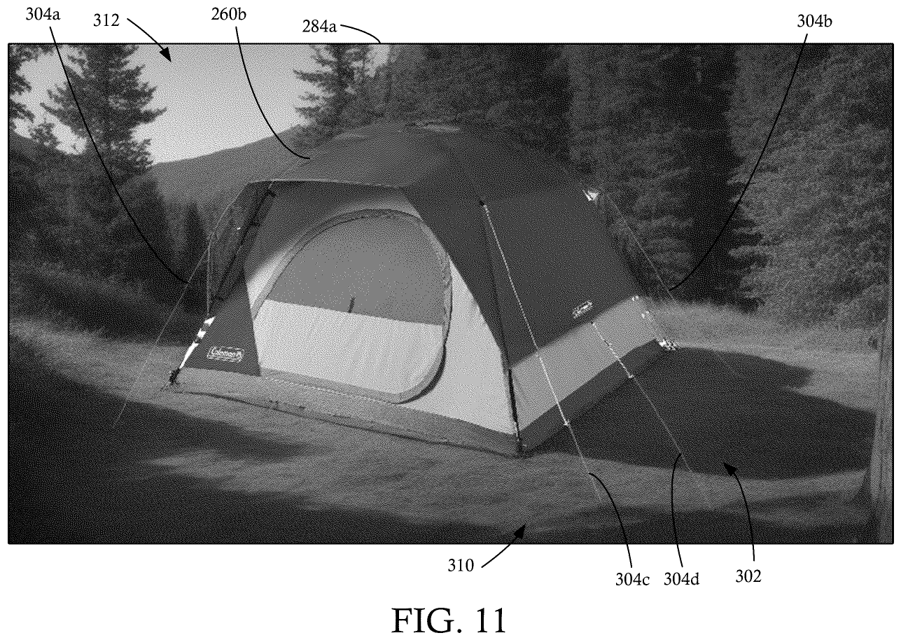

FIG. 11 illustrates a modified composite image 284a. As shown in FIG. 11, a foreground image element 260b (e.g., the outdoor camping tent) is at least partially integrated into background 312 of the revised composite image 284a. For example, the foreground image element 260b is appropriately positioned on a ground portion 310 of the background 312, the background 312 includes a shadow 302 that corresponds to the foreground image element 260b, and additional image elements 304a-304d (e.g., tent guidelines or strings) interact with the foreground image element 260b and the remainder of the background region 312 in an appropriate manner. Although specific embodiments are discussed herein, it will be appreciated that any suitable image elements may be included in the revised composite image 284a to contextually integrate the foreground image element 260b into the background region 312.

FIG. 11 further illustrates distortions that may be introduced during generation of the modified composite image 284a. For example, in the illustrated embodiment, modified composite image 284a includes extension distortions 314a-314c that distort (or change) the foreground image element 260b as compared to the initially isolated foreground image element 260. Although embodiments are discussed herein including extension distortions 314a-314c, it will be appreciated that other types of distortion may be introduced during generation of the modified composite image 284a.

At step 216, a segmented composite image 288 is generated. The segmented composite image 288 is generated by segmenting the modified composite image 284 to identify portions of the modified composite image 284 including the foreground image element 260. In some embodiments, a second image segmentation module 286 is configured to segment, e.g., isolate, the foreground image element 260 within the modified composite image 284.

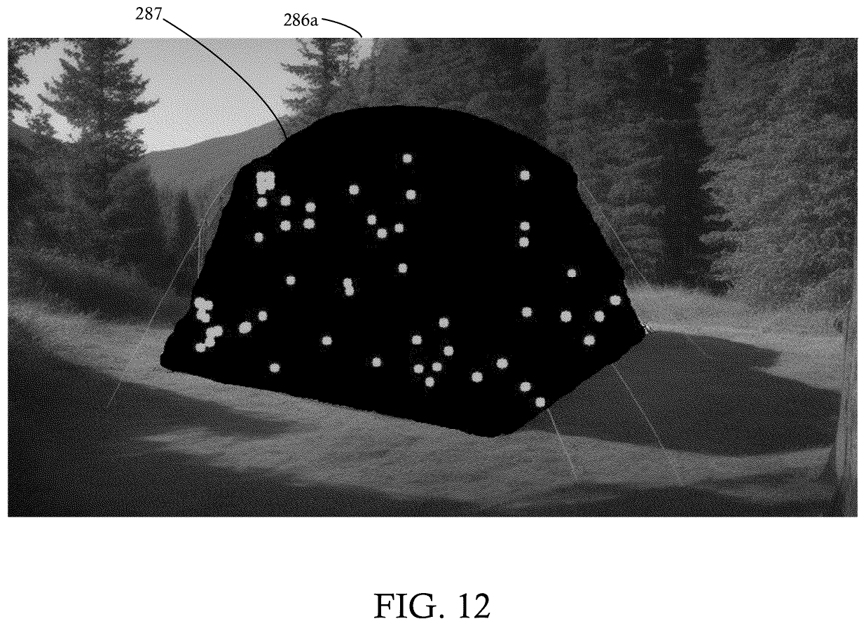

The second image segmentation module 286 may include a separate instance of the first image segmentation model 256 and/or a separately trained image segmentation model. In some embodiments, The second image segmentation module 286 may be configured to correlate portions of a foreground image element 260 with portions of the foreground image element within the modified composite image 284. In some embodiments, the second image segmentation module 286 is configured to remove the foreground image element 260 from the modified composite image 288 while maintaining interactions between the foreground image element 260 and the background, such as shadows, additional image elements, touchpoints, etc. FIG. 12 illustrates a segmented modified composite image 288a having an empty region 287 corresponding to a location and dimension of the foreground image element 260b within the modified composite image.

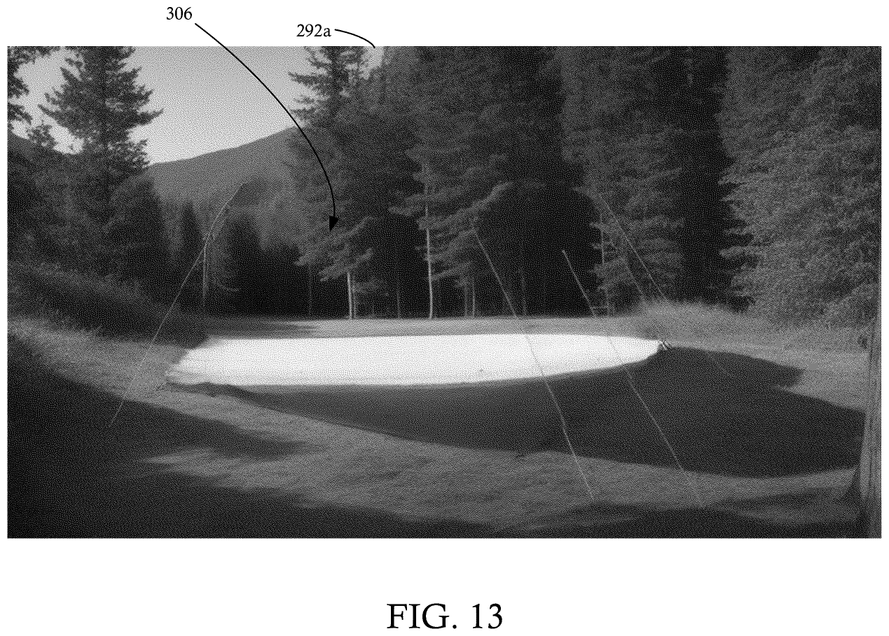

At step 218, a context-appropriate background image 292 is generated by completing (e.g., filling in) the portion of the segmented modified composite image 288 corresponding to the removed foreground image element 260 with background image elements configured to continue and/or match the image elements of the existing portions of the context-appropriate background image 292. In some embodiments, the missing portion is completed by an image completion model 290 configured to generate additional image elements that continuously complete the background region of the segmented modified composite image 288. The image completion model 290 may include a generative image generation model configured to generate image elements for the missing portion of the segmented modified composite image 288. The context-appropriate background image 292 includes a region configured to receive and seamlessly integrate with the foreground image element 260. For example, FIG. 13 illustrates a context-appropriate background image 292a including a region 306 configured to receive the foreground image element 260a (e.g., the outdoor camping tent), in accordance with some embodiments.

At step 220, an integrated image 160 is generated by overlaying the foreground image element 260 on the context-appropriate background image 292 at a position corresponding to the prior position of the foreground image element 260 in the modified composite image 288. By positioning the foreground image element 260 in the same location as in the modified composite image 288, the foreground image element 260 is integrated into the context-appropriate background image 296 at a context-appropriate position. The additional background elements, such as the shadow elements, ground elements, additional image elements, etc. are contextually integrated into the foreground image element 260. In addition, re-insertion of the foreground image element 260 over the context-appropriate background image 292 eliminates any distortions or modifications of the image that may have been generated within the modified composite image 288. The integrated image 160 includes a foreground image element 260 that is unmodified, e.g., is identical to the isolated foreground image 258, while providing integration of the foreground image element 260 into a contextually appropriate background.

In some embodiments, the foreground image element 260 is positioned over the context-appropriate background image 292 based on the identified (e.g. correlated) portions of the foreground image element 260 identified by the second image segmentation module 286. The foreground image element 260 may be positioned over the context-appropriate background image 292 by an image synthesis module 294. The image synthesis module 294 may include a separate instance of the first image synthesis module 272, the same instance of the first image synthesis module 272, and/or a separately generated and/or trained image synthesis module.

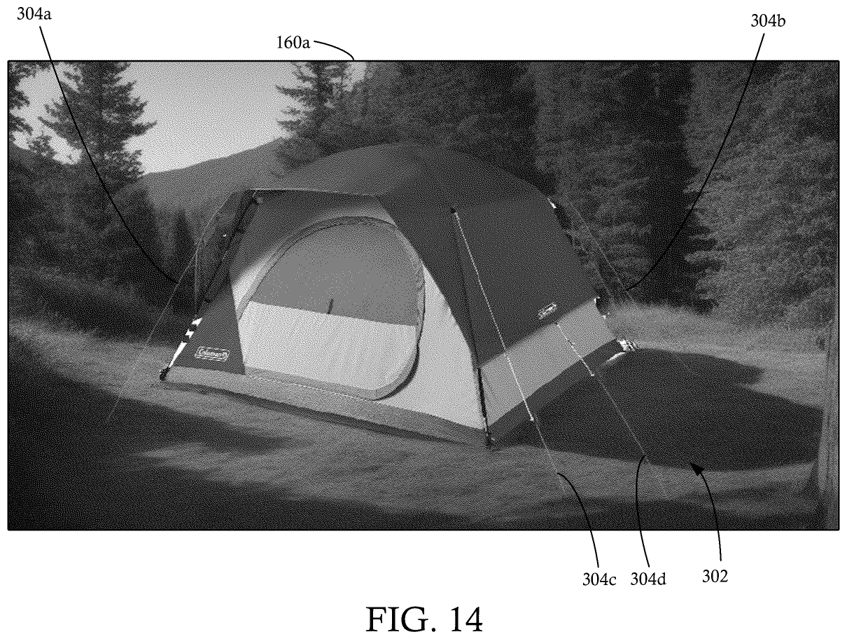

FIG. 14 illustrates an integrated image 160a including the outdoor camping tent foreground image element 260a overlaying the context-appropriate background image 292a at a contextually appropriate position and integrated with the shadow 302 and each of the additional image elements 304a-304d. The integrated image 160a may be output for inclusion in a package data structure, as discussed herein. As shown in FIG. 14, the foreground image element 260a included in the integrated image 160a is identical to the isolated foreground image element 260a as illustrated in FIG. 7, e.g., the foreground image element 260a in the integrated image 160a does not have any distortions or alterations with respect to the original foreground image element.

In some embodiments, one or more filtering and/or review processes may be implemented at various stages to identify and/or prevent generation of undesirable image content. For example, one or more filtering processes may be applied to identify, remove, and/or otherwise eliminate undesirable content such as inappropriate images, offensive images, restricted images, etc. Filtering may occur at any suitable stage of an image generation process, such as, for example, one or more of step 206, 208, 214, 218, etc. Although specific embodiments are discussed herein, it will be appreciated that any suitable filtering may applied at any suitable steps of the disclosed methods.

With reference again to FIGS. 3-4, at step 106, a textual heading element 162 is generated. The textual heading element 162 includes a heading for the selected element to be included on an interface page corresponding to the selected element. The textual heading element 162 may be related to and/or descriptive of the integrated image 160 and/or elements thereof. For example, in the context of an ecommerce environment, the heading element 162 may include a heading for an interface page representative of the item corresponding to the foreground image element 260. To continue the example from above, a heading element 162 generated for a catalog listing related to the outdoor camping tent foreground image element 260a may include textual content related to the outdoor camping tent. Although specific embodiments are discussed herein, it will be appreciated that any suitable heading element may be generated.

In some embodiments, the heading element 162 may be generated by a trained text generation engine 158. The trained text generation engine 158 may include a fine-tuned LLM configured specifically for generation of headings and/or a class of elements including headings. The trained text generation engine 158 may be configured to receive a portion of the data related to the identifier 154, such as one or more features related to the element identified by the identifier 154. As one non-limiting example, in some embodiments, the trained text generation engine 158 may be configured to receive one or more item features, brand features, story features, etc.

At step 108, a textual sub-heading element 164 is generated. The textual sub-heading element 164 includes a sub-heading for the selected element to be included on an interface page corresponding to the selected element. The textual sub-heading element 164 may be related to and/or descriptive of the integrated image 160 and/or elements thereof. For example, in the context of an ecommerce environment, the sub-heading element 164 may include a sub-heading for an interface page representative of the item corresponding to the foreground image element 260. To continue the example from above, a sub-heading element 164 generated for a catalog listing related to the outdoor camping tent foreground image element 260a may include textual content related to the outdoor camping tent. Although specific embodiments are discussed herein, it will be appreciated that any suitable heading element may be generated.

In some embodiments, the sub-heading element 164 may be generated by the trained text generation engine 158. The trained text generation engine 158 may include a fine-tuned LLM configured specifically for generation of sub-headings and/or a class of elements including headings. The trained text generation engine 158 may be configured to receive a portion of the data related to the identifier 154, such as one or more features related to the element identified by the identifier 154. As one non-limiting example, in some embodiments, the trained text generation engine 158 may be configured to receive one or more item features, title, description, attributes, etc. Although embodiments are illustrated herein using the same trained text generation model 158 for generation of each of the heading element 162 and the sub-heading element 164, in some embodiments, individual trained text generation models, such as two separate fine-tuned LLMs, may be utilized to generate each of the heading element 162 and the sub-heading element 164.

At step 110, a package data structure 166 is generated. The package data structure 166 includes each of the generated package elements, e.g., the integrated image 160, the heading element 162, the sub-heading element 164, etc. The package data structure 166 includes a data structure configured to incorporate each of the generated package elements as a data element within the structure.

At step 112, an interface 170 is generated including at least a portion of the package data structure 166. For example, in some embodiments, an interface 170 includes an interface page related to and/or representative of the element corresponding to the identifier 154. The interface 170 may include one or more of the integrated image 160, the heading element 162, the sub-heading element 164, etc. In some embodiments, the interface 170 may enable one or more interactions with one or more of the integrated image 160, the heading element 162, the sub-heading element 164, for example, through programmatically selected navigational shortcuts integrated with each the displayed elements to enable interactions and/or functions through the interface 170. As one non-limiting example, in the context of an ecommerce environment, the interface 170 may include a product or item interface page.

At step 114, feedback data 180 is received. Feedback data 180 may include data representative of interactions and/or rankings of one or more of the outputs (e.g., integrated image 160, heading element 162, sub-heading element 164), included in one or more package data structures 166. The feedback data 180 may include direct feedback and/or indirect feedback. In some embodiments, the feedback data 180 includes positive and/or negative feedback related to the one or more outputs, such as the integrated image 160. In one non-limiting example, negative feedback may include an indication to remove an element from the integrated image 160, e.g., “not in a forest.” As another non-limiting example, positive feedback may include an indication to add or change an element in the integrated image 160, e.g., “generate on an ocean.” Although specific embodiments are discussed herein, it will be appreciated that the feedback data 180 may include any suitable feedback, including natural language feedback. The feedback data 180 may be used to revise one or more of the generated outputs (e.g., integrated image 160, heading element 162, sub-heading element 164).

Generation of context-appropriate interface elements is burdensome and time consuming, requiring use of specially trained individuals to generate proper images for corresponding elements. Interface element package generation systems and methods as disclosed herein significantly reduce this problem, allowing automated generation of context-appropriate integrated images and corresponding text elements, such as headings and sub-headings. For example, in some embodiments described herein, a user identifies an item, for example via an input, and context-appropriate interface elements are automatically generated for the corresponding item. Beneficially, programmatically generating interface elements eliminates the requirement to use highly trained individuals, allowing generation of context-appropriate content by any user interacting with the network environment.

It will be appreciated that automated generation of context-appropriate elements as disclosed herein, is only possible with the aid of computer-assisted machine-learning algorithms and techniques, such as the disclosed LLM and generative image generation models. In some embodiments, machine learning processes including LLM and generative image generation models are used to perform operations that cannot practically be performed by a human, either mentally or with assistance, such as automatic generation of context-appropriate interface elements. It will be appreciated that a variety of machine learning techniques can be used alone or in combination to generate context-appropriate interface elements.

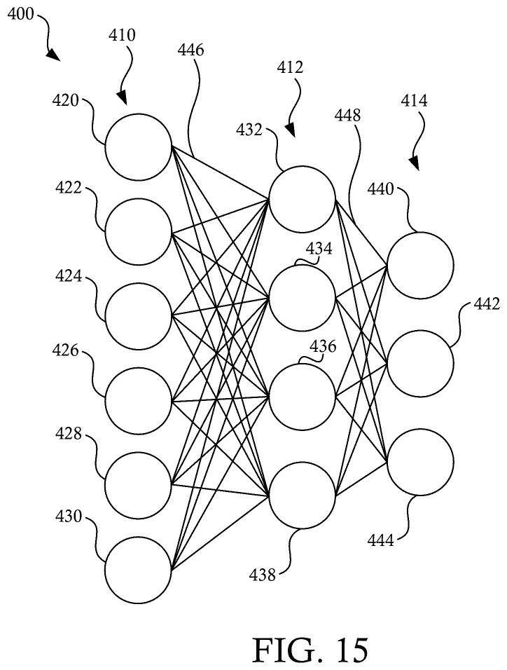

FIG. 15 illustrates an artificial neural network 400, in accordance with some embodiments. Alternative terms for “artificial neural network” are “neural network,” “artificial neural net,” “neural net,” or “trained function.” The neural network 400 comprises nodes 420-444 and edges 446-448, wherein each edge 446-448 is a directed connection from a first node 420-438 to a second node 432-444. In general, the first node 420-438 and the second node 432-444 are different nodes, although it is also possible that the first node 420-438 and the second node 432-444 are identical. For example, in FIG. 15 the edge 446 is a directed connection from the node 420 to the node 432, and the edge 448 is a directed connection from the node 432 to the node 440. An edge 446-448 from a first node 420-438 to a second node 432-444 is also denoted as “ingoing edge” for the second node 432-444 and as “outgoing edge” for the first node 420-438.

The nodes 420-444 of the neural network 400 may be arranged in layers 410-414, wherein the layers may comprise an intrinsic order introduced by the edges 446-448 between the nodes 420-444 such that edges 446-448 exist only between neighboring layers of nodes. In the illustrated embodiment, there is an input layer 410 comprising only nodes 420-430 without an incoming edge, an output layer 414 comprising only nodes 440-444 without outgoing edges, and a hidden layer 412 in-between the input layer 410 and the output layer 414. In general, the number of hidden layer 412 may be chosen arbitrarily and/or through training. The number of nodes 420-430 within the input layer 410 usually relates to the number of input values of the neural network, and the number of nodes 440-444 within the output layer 414 usually relates to the number of output values of the neural network.

In particular, a (real) number may be assigned as a value to every node 420-444 of the neural network 400. Here, xᵢ⁽ⁿ⁾ denotes the value of the i-th node 420-444 of the n-th layer 410-414. The values of the nodes 420-430 of the input layer 410 are equivalent to the input values of the neural network 400, the values of the nodes 440-444 of the output layer 414 are equivalent to the output value of the neural network 400. Furthermore, each edge 446-448 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 420-438 of the m-th layer 410, 412 and the j-th node 432-444 of, the n-th layer 412, 414. Furthermore, the abbreviation w_{i,j}⁽ⁿ⁾ is defined for the weight W_{i,j}^{(m,n+1)}.

In particular, to calculate the output values of the neural network 400, the input values are propagated through the neural network. In particular, the values of the nodes 432-444 of the (n+1)-th layer 412, 414 may be calculated based on the values of the nodes 420-438 of the n-th layer 410, 412 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 410 are given by the input of the neural network 400, wherein values of the hidden layer(s) 412 may be calculated based on the values of the input layer 410 of the neural network and/or based on the values of a prior hidden layer, etc.

In order to set the values w_{i,j}^{(m,n)} for the edges, the neural network 400 has to be trained using training data. In particular, training data comprises training input data and training output data. For a training step, the neural network 400 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 400 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein y is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ(n+1), if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 414, wherein f′ is the first derivative of the activation function, and yⱼ⁽ⁿ⁺¹⁾ is the comparison training value for the j-th node of the output layer 414.

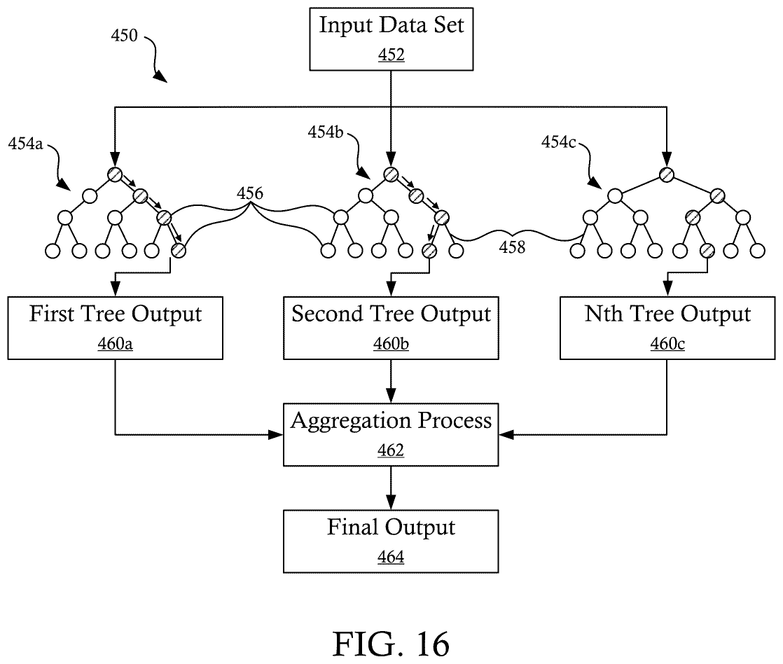

FIG. 16 illustrates a tree-based neural network 450, in accordance with some embodiments. In particular, the tree-based neural network 450 is a random forest neural network, though it will be appreciated that the discussion herein is applicable to other decision tree neural networks. The tree-based neural network 450 includes a plurality of trained decision trees 454a-454c each including a set of nodes 456 (also referred to as “leaves”) and a set of edges 458 (also referred to as “branches”).

Each of the trained decision trees 454a-454c may include a classification and/or a regression tree (CART). Classification trees include a tree model in which a target variable may take a discrete set of values, e.g., may be classified as one of a set of values. In classification trees, each leaf 456 represents class labels and each of the branches 458 represents conjunctions of features that connect the class labels. Regression trees include a tree model in which the target variable may take continuous values (e.g., a real number value).

In operation, an input data set 452 including one or more features or attributes is received. A subset of the input data set 452 is provided to each of the trained decision trees 454a-454c. The subset may include a portion of and/or all of the features or attributes included in the input data set 452. Each of the trained decision trees 454a-454c is trained to receive the subset of the input data set 452 and generate a tree output value 460a-460c, such as a classification or regression output. The individual tree output value 460a-460c is determined by traversing the trained decision trees 454a-454c to arrive at a final leaf (or node) 456.

In some embodiments, the tree-based neural network 450 applies an aggregation process 462 to combine the output of each of the trained decision trees 454a-454c into a final output 464. For example, in embodiments including classification trees, the tree-based neural network 450 may apply a majority-voting process to identify a classification selected by the majority of the trained decision trees 454a-454c. As another example, in embodiments including regression trees, the tree-based neural network 450 may apply an average, mean, and/or other mathematical process to generate a composite output of the trained decision trees. The final output 464 is provided as an output of the tree-based neural network 450.

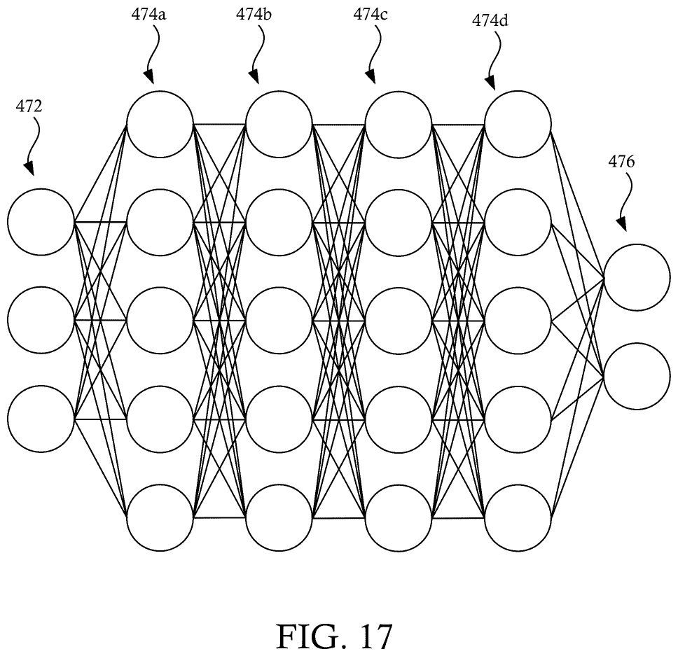

FIG. 17 illustrates a deep neural network (DNN) 470, in accordance with some embodiments. The DNN 470 is an artificial neural network, such as the neural network 400 illustrated in conjunction with FIG. 15, that includes representation learning. The DNN 470 may include an unbounded number of (e.g., two or more) intermediate layers 474a-474d each of a bounded size (e.g., having a predetermined number of nodes), providing for practical application and optimized implementation of a universal classifier. Each of the layers 474a-474d may be heterogenous. The DNN 470 may be configured to model complex, non-linear relationships. Intermediate layers, such as intermediate layer 474c, may provide compositions of features from lower layers, such as layers 474a, 474b, providing for modeling of complex data.

In some embodiments, the DNN 470 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a₍ₗ₎(x) may include a linear operation with matrix W^{(l)} and bias b^{(l)} where:

$${a}^{( l )} ( x ) = {W}^{( l )} x + {b}^{( l )}$$

In some embodiments, the DNN 470 is a feedforward network in which data flows from an input layer 472 to an output layer 476 without looping back through any layers. In some embodiments, the DNN 470 may include a backpropagation network in which the output of at least one hidden layer is provided, e.g., propagated, to a prior hidden layer. The DNN 470 may include any suitable neural network, such as a self-organizing neural network, a recurrent neural network, a convolutional neural network, a modular neural network, and/or any other suitable neural network.

In some embodiments, a DNN 470 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 470 may include a neural multiplicative model (NMM), including a multiplicative form for the NAM mode using a log transformation of the dependent variable y and the independent variable x:

y=e^{β}e^{f(logx})ₑΣᵢfᵢ^{d}(dᵢ)
where d represents one or more features of the independent variable x.

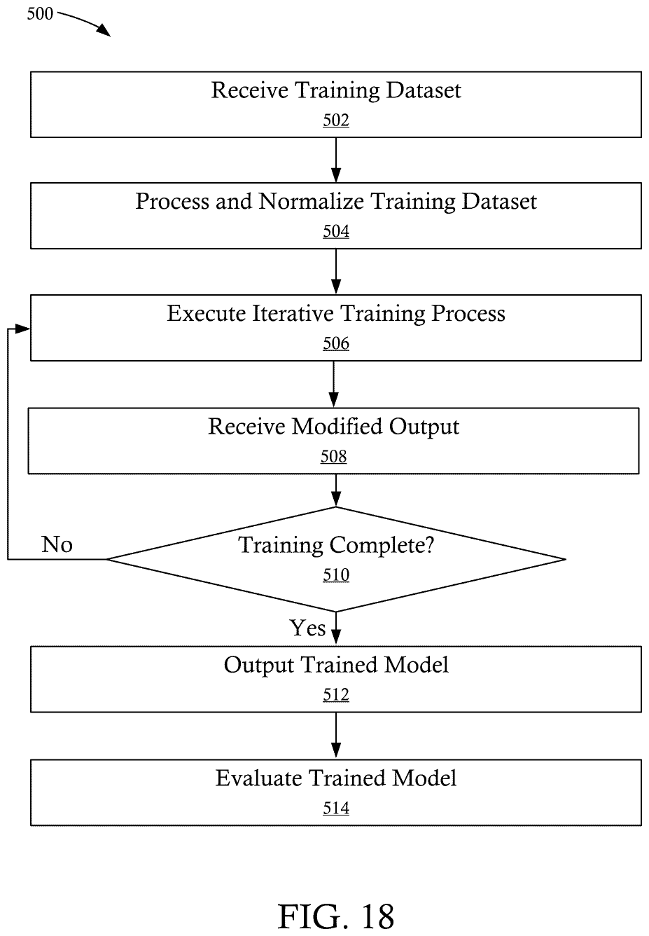

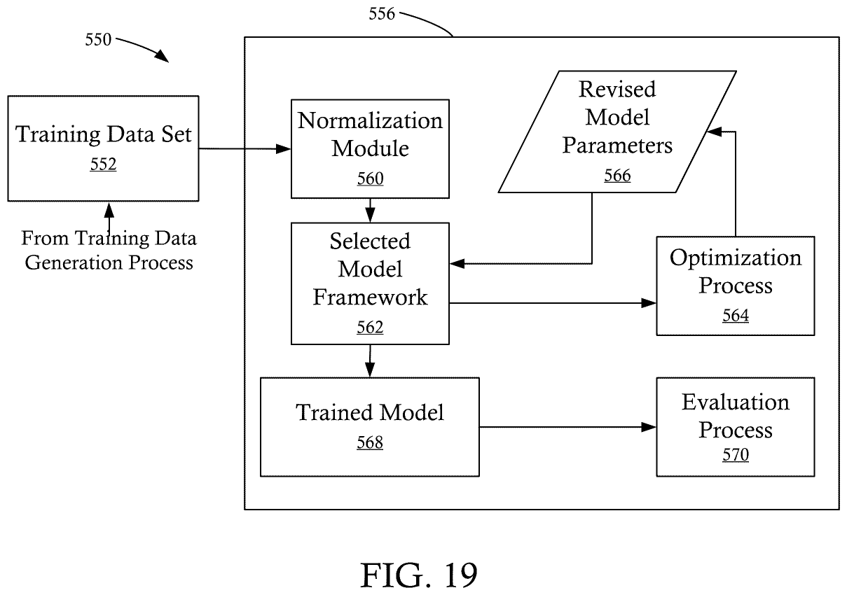

In some embodiments, one or more trained models can be generated using an iterative training process based on a training dataset. FIG. 18 illustrates a method 500 for generating a trained model, such as a trained optimization model, in accordance with some embodiments. FIG. 19 is a process flow 550 illustrating various steps of the method 500 of generating a trained model, in accordance with some embodiments. At step 502, a training dataset 552 is received by a system, such as a processing device 10. The training dataset 552 can include labeled and/or unlabeled data.

At optional step 504, the received training dataset 552 is processed and/or normalized by a normalization module 560. For example, in some embodiments, the training dataset 552 can be augmented by imputing or estimating missing values of one or more features. In some embodiments, processing of the received training dataset 552 includes outlier detection configured to remove data likely to skew training of a model. In some embodiments, processing of the received training dataset 552 includes removing features that have limited value with respect to training of the a relevant model.

At step 506, an iterative training process is executed to train a selected model framework 562. The selected model framework 562 can include an untrained (e.g., base) machine learning model and/or a partially or previously trained model (e.g., a prior version of a trained model). The training process is configured to iteratively adjust parameters (e.g., hyperparameters) of the selected model framework 562 to minimize a cost value (e.g., an output of a cost function) for the selected model framework 562.

The training process is an iterative process that generates set of revised model parameters 566 during each iteration. The set of revised model parameters 566 can be generated by applying an optimization process 564 to the cost function of the selected model framework 562. The optimization process 564 can be configured to reduce the cost value (e.g., reduce the output of the cost function) at each step by adjusting one or more parameters during each iteration of the training process.

After each iteration of the training process, at step 508, a determination is made whether the training process is complete. The determination at step 508 can be based on any suitable parameters. For example, in some embodiments, a training process can complete after a predetermined number of iterations. As another example, in some embodiments, a training process can complete when it is determined that the cost function of the selected model framework 562 has reached a minimum, such as a local minimum and/or a global minimum.

At step 510, a trained model 568, is output and provided for use in one or more processes, such as an interface element package generation process 100, discussed above. At optional step 512, a trained model 568 can be evaluated by an evaluation process 570. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a processor; and
a non-transitory memory storing instructions that, when executed, cause the processor to:
receive a request to generate an interface element package for a selected item;
in response to receiving the request:
generate a foreground image element;
generate a contextually appropriate background image; and
generate an integrated image by integrating the foreground image element into the contextually appropriate background image at a contextually appropriate position, wherein the foreground image element is unmodified in the integrated image;
generate at least one textual interface element; and
generate the interface element package including at least the integrated image and the textual interface element.

2. The system of claim 1, wherein the foreground image element comprises an isolated foreground image.

3. The system of claim 2, wherein the isolated foreground image is generated by an image segmentation model.

4. The system of claim 1, wherein the contextually appropriate background image is generated by a diffusion-based image generation model.

5. The system of claim 4, wherein the diffusion-based image generation model receives an image generation prompt describing a contextual background generated by a prompt generation model.

6. The system of claim 1, wherein the instructions cause the processor to generate the contextually appropriate background image by:
generating an initial background image;
generating a composite image by overlaying the foreground image element on the initial background image; and
generating the contextually appropriate background image by regenerating the initial background image in view of a position of the foreground image element in the composite image.

7. The system of claim 1, wherein the textual interface element is descriptive of the integrated image.

8. A computer-implemented method, comprising:
receiving a request to generate an interface element package for a selected item;
in response to receiving the request:
generating a foreground image element;
generating a contextually appropriate background image; and
generating an integrated image by integrating the foreground image element into the contextually appropriate background image at a contextually appropriate position, wherein the foreground image element is unmodified in the integrated image; and
generating at least one textual interface element; and
generating the interface element package including at least the integrated image and the textual interface element.

9. The computer-implemented method of claim 8, wherein the foreground image element comprises an isolated foreground image.

10. The computer-implemented method of claim 9, wherein the isolated foreground image is generated by an image segmentation model.

11. The computer-implemented method of claim 8, wherein the contextually appropriate background image is generated by a diffusion-based image generation model.

12. The computer-implemented method of claim 11, wherein the diffusion-based image generation model receives an image generation prompt describing a contextual background generated by a prompt generation model.

13. The computer-implemented method of claim 8, wherein generating the contextually appropriate background image comprises:
generating an initial background image;
generating a composite image by overlaying the foreground image element on the initial background image; and
generating the contextually appropriate background image by regenerating the initial background image in view of a position of the foreground image element in the composite image.

14. The computer-implemented method of claim 8, wherein the textual interface element is descriptive of the integrated image.

15. A non-transitory computer readable medium having instructions stored thereon, wherein the instructions, when executed by at least one processor, cause at least one device to perform operations comprising:
receiving a request to generate an interface element package for a selected item;
in response to receiving the request:
generating a foreground image element;
generating a contextually appropriate background image; and
generating an integrated image by integrating the foreground image element into the contextually appropriate background image at a contextually appropriate position, wherein the foreground image element is unmodified in the integrated image;
generating at least one textual interface element; and
generate the interface element package including at least the integrated image and the textual interface element.

16. The non-transitory computer readable medium of claim 15, wherein the foreground image element comprises an isolated foreground image generated by an image segmentation model.

17. The non-transitory computer readable medium of claim 15, wherein the contextually appropriate background image is generated by a diffusion-based image generation model.

18. The non-transitory computer readable medium of claim 17, wherein the diffusion-based image generation model receives an image generation prompt describing a contextual background generated by a prompt generation model.

19. The non-transitory computer readable medium of claim 15, wherein generating the contextually appropriate background image comprises:
generating an initial background image;
generating a composite image by overlaying the foreground image element on the initial background image; and
generating the contextually appropriate background image by regenerating the initial background image in view of a position of the foreground image element in the composite image.

20. The non-transitory computer readable medium of claim 15, wherein the textual interface element is descriptive of the integrated image.
